(19) United States
(12) Patent Application Publication
(10) Pub. No.: US 2023/0140175 A1
(43) Pub. Date: May 4, 2023

(54) Method for Producing an Electrode

(71) Applicant: Bayerische Motoren Werke Aktiengesellschaft, Muenchen (DE)

(72) Inventors: Sung-Jin KIM, Muenchen (DE); Thomas WOEHRLE, Muenchen (DE)

(21) Appl. No.: 17/802,603

(22) PCT Filed: Feb. 2, 2021
(86) PCT No.: PCT/EP2021/052365

§ 371 Date: Aug. 26, 2022

(30) Foreign Application Priority Data
Feb. 27, 2020 (DE) 10 2020 105 156.5

(51) Int. Cl. H01M 4/04; H01M 10/0525

(52) U.S. Cl. CPC H01M 4/0435; H01M 4/0471; H01M 10/0525

(57) ABSTRACT

Please substitute the new Abstract submitted herewith for the original Abstract: A method for producing an electrode, especially for a lithium-ion battery, includes providing an uncoated carrier material, machining the carrier material to produce at least one single sheet, coating the single sheet, and adjusting the porosity of the electrode at the single sheet level.

### FIELD

The present invention relates to a method for producing an electrode for an energy storage cell, in particular for a lithium ion battery or a lithium ion accumulator, to an electrode, to an electrode stack, to an energy storage unit and to a traction battery.

### BACKGROUND AND SUMMARY

The electrodes in question are in particular single sheet electrodes, such as are used in electrode stacks. The electrodes are formed by films coated with a coating compound. After the coating and drying, the electrode is compacted, particularly in order to adjust a porosity, for example by a calender process, cut to target width (for example with rotary shears) and then divided into single sheets after carrying out a contour cut, and optionally stacked. During the calendering, the problem often arises that undesired deformations occur in all regions of the films. Particularly in the uncoated regions of the carrier film, for example folds which lead to quality losses, and inter alia make further processing of the films more difficult, occur because of the application of force. Because of the preliminary damage, cracks, corrugations and the like may thus be formed in downstream process steps, for example when trimming the films. Film cutting by means of a laser may also be made more difficult since it is not possible to focus correctly. In order to counteract these problems, EP 2 296 209 A1 proposes heating of the uncoated regions of the carrier film. DE 10 2017 215 143 A1 uses a metal film which, when it is spread out in a web plane as a web, has a curvature lying in the web plane. This curvature is removed by a corresponding pressure application during the calendering, the aforementioned undesired deformation effect not being intended to be present in the final material. The known approaches, however, are very elaborate in terms of manufacturing technology and are cost-intensive.

It is therefore an object of the present invention to provide a method for producing an electrode, an electrode, an electrode stack, an energy storage unit and a traction battery, which do not have the aforementioned problems.

This object is achieved by a method, an electrode, an electrode stack, an energy storage unit and a traction battery according to the present disclosure. Further advantages and features may be found from the description and the appended figures.

According to the invention, a method for producing an electrode, particularly a composite electrode, in particular for an energy storage cell, such as for example a lithium ion cell, comprises the steps:
providing an uncoated carrier material;
processing the carrier material in order to produce at least one single sheet;
coating the single sheet, in particular in order to produce or generate an electrode, in particular with a coating compound; and
adjusting a porosity of the electrode on the single sheet or of the single-sheet electrode.

Advantageously the conventional process chain, according to which the carrier material is initially coated and its compacting to adjust the porosity is then carried out, is modified. Before coating the electrode, the step of producing the single sheet is instead advantageously effected upstream, according to the footprint of the cell. Only then is coating effected, in particular with a coating compound, on one or both sides. According to one embodiment, the coating compound comprises an active material, electrode binder, conductive carbon black (optionally conductive graphite) and carrier solvent. The carrier material is, in particular, a carrier film. According to one embodiment, the carrier material is in the form of a web or is present in the form of a web. Depending on whether the electrode is an electrode for the anode or the cathode, the material of the carrier film is selected accordingly. In the case of the anode, the carrier film is typically a copper film, and in the case of the cathode the carrier film is typically an aluminum film. Preferred film thicknesses vary, depending on the cell design, for example between 6 μm and 25 μm. The aluminum film is preferably rolled. The copper film is preferably rolled or electrolytically produced. The carrier films are not limited, and may also be stamped films or expanded metals in any desired geometry. The carrier material or carrier film is coated on one or two sides. This is done for example with suitable application tools such as slot dies, blades, anilox rolls, etc. As an alternative, the carrier material may also be a plastic film which is coated in a suitable way, for example with a metal. By the adjustment of the porosity of the electrode on the single sheet, the aforementioned disadvantages or problems, such as the crack formation mentioned, the folding, etc. are avoided.

Preferably, the electrode is configured as a cathode or anode for a lithium ion cell. The aforementioned cell type does not, however, represent a restriction. Alternative applications, for example for lithium-sulfur cells, are also preferred.

According to one embodiment, the method comprises the step:
processing by cutting out or trimming by means of a thermal or mechanical cutting method.

Advantageously, in the present case the blank, uncoated carrier film is cut or trimmed. Preferred mechanical cutting methods are inter alia shearing, stamping, particle cutting or water jet cutting. A preferred thermal cutting method is, for example, laser cutting.

According to one embodiment, the cutting out or trimming is carried out near net shape. As an alternative, the desired net shape may already be produced in this step, in particular exactly.

According to one embodiment, the method comprises the steps:
shaping a lead region during the processing of the carrier material; and
coating the single sheet, apart from the lead region, in order to produce the electrode.

Advantageously, during the production of the single sheet, the latter is already produced in accordance with its net shape or at least in a near-net-shape manner. The processing is expediently effected in such a way that the single sheet already comprises or has the lead region. The lead region is later used to contact or connect the electrodes to one another.

As an alternative, the single sheet may also be coated in a full-area manner, including the lead region. The coating on the lead region can be removed subsequently.

According to one embodiment, the method comprises the steps:
coating strips or regions of the single sheet in order to generate or produce electrodes; and
shaping a lead region after the adjustment of the porosity.

In this embodiment, for example, the single sheet is coated in such a way that one or two uncoated regions, in particular strips, remain free peripherally. This may be advantageous in relation to handling of the single sheet, since these regions, apart from the lead region, are later removed. Thus, it is readily possible to use a machine device in this case, for example a robot or the like, with a gripper etc. In this case, the uncoated regions are advantageously configured to be so narrow that no problems occur during the subsequent adjustment of the porosity, for example by means of calendering.

According to one embodiment, the method comprises the step:
adjusting the porosity by pressing and/or rolling.

During pressing, the pressure is applied perpendicularly or substantially perpendicularly, or in a normal direction, onto the single sheet, on one or both sides. For this purpose, corresponding presses or pressing dies may be used. Very non-invasive processing may therefore advantageously be achieved. According to one embodiment, rolling is carried out in a calender.

According to one embodiment, the method comprises the step:
rolling along different rolling directions.

The rolling may, for example, be carried out in a calender. Since this is not a conventional roll-to-roll process, no mechanical stress takes place on the electrode, or the single sheet, due to tensile forces. The risk of tearing the single sheet or the uncoated regions is therefore substantially eliminated. According to one embodiment, at least one calender roll is heated in order to facilitate the compacting.

Particularly advantageously, it is thereby possible to achieve greater compression of the electrode and therefore to achieve a higher electrode density. Consequently, higher powers and higher energy densities can be achieved with such electrodes.

Particularly advantageously, in the present case it is also possible to roll along different rolling directions, or to combine different compacting methods, for example first compacting with a die tool and then compacting by means of rolls in a calender. In this case, the aforementioned rolling directions may for example be perpendicular or substantially perpendicular to one another, in order to compensate for any deformations.

According to one embodiment, the method comprises the step:
moving or transporting the single sheets by means of suction pads.

For the removal and feed of the uncoated and coated single sheets, which may for example be temporarily stored in magazines, it is possible to use suction pads, which may also be automated with robotics.

According to one embodiment, the method comprises the step:
moving or transporting the single sheets by means of transport films.

According to one embodiment, the single sheets are guided and positioned on a polyester film, and according to one embodiment they are also specially protected, in particular mechanically and thermally, between two polyester films.

According to one embodiment, the method comprises the step:
coating the single sheet by a method selected from one of the following: lamination, adhesive bonding, masking, extrusion, dry coating, wet coating, direct wet coating, etc.

After the coating, a drying process is generally carried out. In the case of wet coating, the so-called carrier solvent (for example water) is in this case extracted. In general, vacuum drying in which the residual moisture in the electrode is reduced also follows.

According to one embodiment, the method comprises the step:
recutting the single sheet after the adjustment of the porosity.

According to one embodiment, the final shape of the single sheet, in other words its net shape, is produced in this step. As already indicated, this method step may also be configured in such a way that the lead region is thereby also formed. The mechanical and/or thermal cutting methods already mentioned are preferably used for the cutting.

According to one embodiment, the single sheet is coated in a full-area manner, in particular also comprising the lead region which may have already been formed. According to one embodiment, the lead region is accordingly freed from the coating or coating compound, for example by means of mechanical or thermal methods.

The invention also relates to an electrode, in particular a composite electrode, in particular for an energy storage cell, a lithium ion battery or a lithium ion accumulator, comprising a carrier material which has single sheet dimensions, and wherein the carrier material has a coating which is uncompacted. Preferably it is an uncompacted single sheet electrode. The electrode preferably has no uncoated region, or only a very small uncoated region. The risk of tearing the electrode, or the positions on the carrier material which are not coated, therefore no longer exists and greater compression of the electrode and therefore the achievement of a higher electrode density are made possible. It has been found that such an electrode can be processed further very well.

The invention also relates to an electrode stack comprising a multiplicity of electrodes, cathodes and anodes, produced by the method according to the invention and arranged in the form of a stack. In order to make the electrode stack, the electrodes are used together with a separator. All known separators may be made and applied to form a single sheet.

According to one embodiment, the electrode stack is configured as a single sheet stack. As an alternative, the electrode stack is configured as a double-cell stack.

The invention furthermore relates to an energy storage unit comprising an electrode stack according to the invention. The energy storage unit may, according to one embodiment, be a lithium ion cell or a lithium-sulfur cell.

According to one embodiment, the energy storage unit comprises a solid cell housing, which in particular has a prismatic shape. As an alternative, the energy storage unit may be configured as a pouch bag or soft pack, which is soft packaging consisting of highly processed composite aluminum film. Alternative cell housing forms are likewise possible. In principle, the stacking of the electrodes allows extremely highly efficient use of an angular, in particular cubic or cuboid, cell housing, cf. in particular the aforementioned prismatic cell housing.

The invention furthermore relates to a traction battery comprising at least one energy storage unit according to the invention. The traction battery is preferably designed for use in a motor vehicle such as an automobile, a motorcycle or a commercial vehicle.

Further features and advantages may be found from the following description of embodiments of methods with reference to the appended figures. Different features may in this case be combined with one another in the scope of the invention.

### BRIEF DESCRIPTION OF THE FIGURES

FIG. 1 shows a schematic representation of one embodiment of a method sequence according to the invention for producing an electrode; and

FIG. 2 shows a schematic representation of an alternative method sequence according to one embodiment of the method according to the invention.

### DETAILED DESCRIPTION

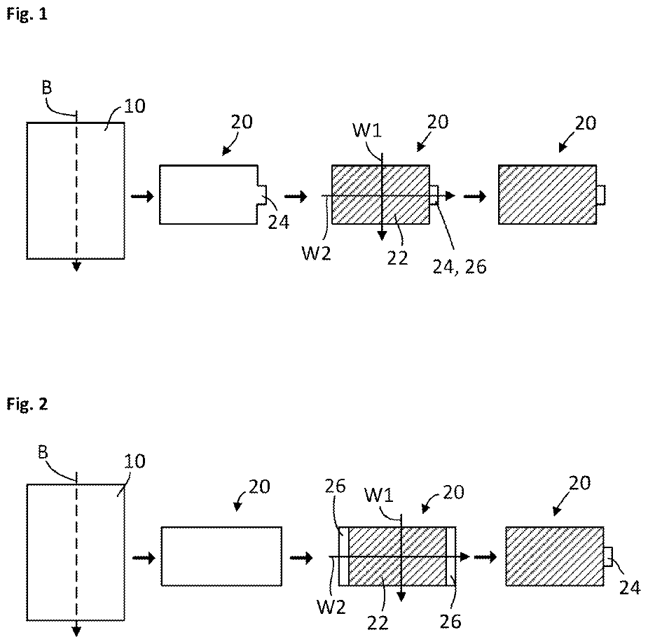

FIG. 1 shows, on the left-hand side, a carrier material or a carrier film 10 which extends along a web direction. The carrier film 10 is, for example, wound onto a roll, a piece of unwound material being outlined here. A single sheet 20 is formed from the carrier film 10 in a cutting process. It is expediently possible for a multiplicity of such single sheets 20 to be cut out of such a carrier film 10. In this case, for example, the length of the single sheet 20 corresponds substantially to a width of the carrier film 10. As an alternative, the width of the carrier film 10 may also be a multiple of the length or of the width of the single sheet 20. In the embodiment illustrated here, the present single sheet 20 already has a lead region 24. The single sheet 20 has no coating. This is effected only in a next step, cf. reference 22. After the carrier film 10 has been trimmed to the single sheet dimensions, the coating is thus advantageously effected, in particular with coating compound, in particular on one or both sides, preferably on both sides, cf. reference 22. The lead region 24 is expediently left blank. As an alternative, the single sheet 20 may also be coated in a full-area manner, in which case the lead region 24 is then exposed again in a subsequent step. Reference 26 denotes an uncoated region of the single sheet 20. The adjusting of the porosity of the electrode and the compacting or pressing is effected only on the single sheet 20, it being possible for compacting to be effected along different directions here, cf. a first rolling direction W1 and a second rolling direction W2. Compacting along different directions increases the process stability, since any deformations can be compensated for optimally. After the pressing or compacting of the electrodes, recutting of the single sheet to net shape is optionally carried out in a final step. This step may also be omitted however, depending on the embodiment.

FIG. 2 shows an alternative embodiment of a method for producing an electrode, the essential steps being known however from FIG. 1. One crucial difference is that a lead region 24 is not already jointly produced when producing a single sheet 20 from a carrier film 10. Instead, the lead region 24 is not produced until in a final processing step. In the embodiment illustrated here, the single sheet 20 is coated in strips or in regions, cf. the reference 22, such that uncoated regions 26 remain. These may advantageously be used to handle the single sheet 20 better in the process. In this case, the uncoated regions 26 are configured to be so small that no folds, cracks or the like occur during the pressing, compacting or calendering.

### LIST OF REFERENCES

10 carrier material, carrier film

20 single sheet

22 coating, coating compound

24 lead region

26 uncoated region

W1 first rolling direction

W2 second rolling direction

B web direction

1-15. (canceled)

16. A method for producing an electrode for an energy storage cell, comprising:
providing an uncoated carrier material;
processing the carrier material to produce at least one single sheet;
coating the single sheet; and
adjusting a porosity of the electrode on the single sheet.

17. The method according to claim 16, comprising:
processing by cutting out or trimming by thermal or mechanical cutting.

18. The method according to claim 16, comprising:
shaping a lead region during the processing of the carrier material; and
coating the single sheet apart from the lead region.

19. The method according to claim 16, comprising:
coating strips of the single sheet; and
shaping a lead region after the adjustment of the porosity.

20. The method according to claim 16, comprising:
adjusting the porosity by pressing and/or rolling.

21. The method according to claim 20, comprising:
rolling along different rolling directions.

22. The method according to claim 16, comprising:
moving the single sheets using suction pads.

23. The method according to claim 16, comprising:
moving the single sheets by using transport films.

24. The method according to claim 16, comprising:
recutting the single sheet after the adjustment of the porosity.

25. The method according to claim 16, comprising:
coating the single sheet by a method selected from at least one of the following: lamination, adhesive bonding, masking, extrusion, dry coating, wet coating, or direct wet coating.

26. An electrode, comprising a carrier material which has single sheet dimensions,
wherein the carrier material has a coating which is uncompacted.

27. An electrode stack comprising a plurality of electrodes arranged in the form of a stack, wherein the plurality of electrodes is produced by the method according to claim 16.

28. The electrode stack according to claim 27,
wherein the electrode stack is configured as a single sheet stack or as a double-cell stack.

29. An energy storage unit comprising the electrode stack according to claim 27.

30. A traction battery comprising the energy storage unit according to claim 29.
